(19) United States
(12) Patent Application Publication
(10) Pub. No.: US 2001/0037005 A1
(43) Pub. Date: Nov. 1, 2001

(54) Polymerisation catalysts

(76) Inventor: Richard Henry Weatherhead, Addlestone (GB)

Correspondence Address: NIXON & VANDERHYE P.C., 8th Floor, 1100 North Glebe Road, Arlington, VA, 22201-4714, US

(21) Appl. No.: 09/777,014

(22) Filed: Feb. 6, 2001

Related U.S. Application Data
(63) Continuation of application No. PCT/GB99/02467, filed on Jul. 28, 1999.

(30) Foreign Application Priority Data
Aug. 6, 1998 (GB) P 9817015.2

(51) Int. Cl. C08F 4/44

(52) U.S. Cl. 526/160; 526/348.6; 526/348.3; 526/943; 502/152; 502/117; 502/155

(57) ABSTRACT

A catalyst system suitable for preparing substantially terminally unsaturated atactic polymers or copolymers of α-olefins having a number average molecular weight in the range 300-500,000 comprises: A) a metallocene complex; and B) a cocatalyst comprising: i) an aluminoxane; and ii) a Group III metal alkyl compound having at least 2 carbon atoms. The use of the Group III metal compound allows for a reduction in the aluminoxane content in the cocatalyst. Preferred metallocenes are those having alkyl substitution on the cyclopentadienyl rings and the preferred Group III metal alkyl compound is triisobutyl aluminum.

The present invention relates to a catalyst system for use in the preparation of substantially terminally unsaturated polyolefins.

Substantially terminally unsaturated polyolefins where the terminal group in the polymer is a vinylidene group have been used as starting materials for the preparation of a variety of compounds for example oil additives, sealants, dispersants, cleaning agents, etc. Such terminally unsaturated polyolefins, especially poly(iso)butenes, have been prepared using various catalysts such as eg boron trifluoride as claimed and described in our EP-A-0145235 and EP-A-0671419. Other processes have been used to produce conventional polymers of 1-olefins using catalysts such as metallocenes alone or in combination with an activator/cocatalyst such as methylaluminoxane. Polyolefins which can be produced by the latter method include homopolymers of propylene, 1-butene, 1-pentene, 1-hexene and 1-octene as well as copolymers of such olefins with one another, in particular copolymers of propylene eg with ethylene. Such polyolefins are characterised by a low molecular weight typically in the range 300-5000.

A particular advantage of such terminally unsaturated polymers is their high degree of reactivity especially towards enophiles such as unsaturated dicarboxylic acid anhydrides which make them particularly suitable for the ene/enophile reactions which enable functionalisation of such polymers into useful products such as lubricating oil additives.

For example EP-A-353935 describes ethylene/alpha-olefin copolymer substituted mono- and dicarboxylic acid lubricant dispersant additives in which the ethylene copolymer is prepared by use of bis(n-butylcyclopentadienyl) zirconium dichloride catalyst and methylaluminoxane (MAO) cocatalyst.

EP-A-490454 describes alkenyl succinimides as lube oil additives comprising an alkenyl substituent group derived from a propylene oligomer which is conveniently prepared using as a catalyst a bis(cyclopentadienyl)zirconium compound and cocatalyst MAO.

Similarly, EP-A-268214 describes the use of an alkyl substituted cyclopentadienyl compound of zirconium or hafnium for the oligomerisation of propylene. A vast number of compounds are listed which include inter alia [(CH3)₅C₅]₂ZrCl₂. However, all the compounds listed are bis(penta-alkyl substituted cyclopentadiene) derivatives of zirconium or hafnium and these tend to give rise to polymers in which the terminal unsaturated linkage is predominantly a vinyl linkage.

In such prior art preparations the metallocene/cocatalyst systems are used in solution phase with the metallocene/cocatalyst dissolved in or miscible with the liquid reactants or in an inert solvent containing dissolved gaseous reactants.

In our published application WO 99/05182 metallocene complexes are disclosed having ligands comprising 1,3-diketone, β-ketoester or trifluoromethane sulphonate groups. Such complexes are suitable for the preparation of substantially terminally unsaturated polyolefins. Such complexes may also be suitably substituted on the cyclopentadienyl rings with alkyl groups.

In the above referenced systems the metallocene complexes are suitably used in the presence of cocatalysts, in particular aluminoxanes eg methyl aluminoxane (MAO). However a disadvantage of these systems is that an excessive amount of expensive MAO may be required eg aluminium to transition metal ratio of 1000:1.

We have now found that a significant amount of the MAO may be replaced by a Group III metal alkyl compound having at least 2 carbon atoms eg triisobutylaluminium without any loss of the benefits associated with MAO. Further the ratio of aluminium (based on MAO) to transition metal may be in the range 100:1 without any loss of catalytic activity.

Thus according to the present invention there is provided a catalyst system suitable for use for the preparation of substantially terminally unsaturated atactic polymers or copolymers of α-olefins having a number average molecular weight in the range 300-500,000 said catalyst system comprising (A) a metallocene of formula:

[RₘCpH₍₅₋ₘ₎][RₙCpH₍₅₋ₙ₎]M(Z)Y

wherein

CpH is a cyclopentadienyl ligand,

Each R represents an alkyl or an aryl substituent on the CpH ligand or two R groups may be joined together to form a ring, or the R groups in each CpH group when taken together represents an Si or C bridging group linking two CpH groups wherein said Si or C group may itself be substituted by hydrogen atoms or C1-C3 alkyl groups,

M is a metal selected from hafnium, zirconium and titanium,

Z and Y are selected from hydrogen, halide, a trifluoromethyl sulphonate (hereafter “triflate”), a 1,3-diketone, a β-ketoester, an alkyl or an aryl group, and may be the same or different.

each of m and n is the same or different and has a value from 0 to 5, and

(B) a cocatalyst comprising (i) an aluminoxane and (ii) a Group III metal alkyl compound having at least 2 carbon atoms.

Unless otherwise specified, the terms (co) polymers and (co) polymerisation are used herein and throughout the specification to cover the homopolymerisation and copolymerisation of α-olefins as well as including oligomerisation.

By substantially terminally unsaturated polymers or copolymers is meant polymers or copolymers having ≧60% polymer chains which contain terminal unsaturation.

More specifically, the preferred catalysts of the present invention that may be used to (co)polymerise α-olefins include bis(alkyl cyclopentadienyl) metallocenes wherein R is suitably a methyl group. Thus, the alkyl substituent on the cyclopentadienyl ligands in the metallocene may be a methyl-; 1,3-dimethyl-; 1,2,4-trimethyl-; tetramethyl- group or may be substituted with methyl ethyl isobutyl groups or mixtures thereof Where R represents a substituted or unsubstituted silicon or carbon bridging group linking two CpH ligands, such metallocenes are suitably dimethylsilyl dicyclopentadienyl-zirconium, -hafnium or -titanium compound.

When two R groups are joined together the cyclopentadienyl ligand may be represented by indenyl or hydrogenated indenyl.

The metal M in the metallocene may be zirconium, hafnium or titanium. Of these zirconium is preferred.

The preferred Y and Z ligands are halide in particular chloride.

The group Y or Z in the metallocene may also be selected from a 1,3-diketone group, a β-ketoester and a triflate. The diketonate comprises an anion of the formula

[R¹—C(O)—C(R²)—C(O)—R³]⁻

where R¹, R² and R³ may be the same or different alkyl or aryl groups or halogenated alkyl groups and in addition R² may be a hydrogen atom. The keto-ester anion comprises anions of the formula

[R¹—C(O)—C(R²)—C(O)—OR³]⁻

where R¹, R² and R³ may be the same or different alkyl or aryl groups or halogenated alkyl groups and in addition R² may be a hydrogen atom.

Preferred metallocene catalysts which carry a methyl or a 1,3-dimethyl or a 1,2,4-trimethyl cyclopentadienyl ligands (ie when n is 1-3) give rise to (co)polymers in which the terminal unsaturation is predominantly a vinylidene group suitably >97%, preferably >99% vinylidene. However, where the value of each of m and n in these catalysts is 4 or 5, the product may comprise a significant proportion of vinyl terminated chains.

The cocatalyst comprises an aluminoxane and a Group III metal alkyl compound having at least 2 carbon atoms. The preferred aluminoxane is methyl aluminoxane (MAO) and the preferred Group III metal alkyl compound is a trialkylaluminium or a trialkylboron compound. A particularly preferred trialkylaluminium is triisobutylaluminium (TIBAL).

Other suitable Group III metal alkyl compounds are, for example tri(n-propyl) aluminium or tri(sec-butyl) boron.

The concentration of the Group III metal alkyl is most beneficial in a range between a minimum that is required to neutralise any harmful impurities present in the feedstock and a maximum governed by its potential to degrade the activating effect of the aluminoxane.

Within this range the mole ratio of the Group III metal alkyl to aluminoxane (calculated as moles of A1 present as aluminoxane) is in the range 100:1 to 1:0.01 and most preferably in the range 10:1 to 1:1.

The mole ratio of metal to aluminoxane (as active aluminium) is suitably in the range 1:1 to 1:2000, preferably in the range 1:10 to 1:1000 and most preferably in the range 1:50 to 1:400.

The metallocene catalyst and/or the cocatalyst may suitably be supported on supports which include organic and inorganic materials such as polymers and inorganic metal and non-metal oxides, in particularly porous materials. While conventional support materials may be suitable, supports with particularly high porosity are preferred due to their ability to facilitate maximum contact between the reactants and catalyst while retaining the catalyst in supported form.

Examples of suitable support materials are macroporous or mesoporous silica or other non-metal or metal-oxides such as alumina, titania or mixtures of oxides. Alternatively the support may be a polymer. A preferred support is silica.

An important feature of the present invention is that these catalysts, when used to catalyse the (co)polymerisation of α-olefins, give a product which is substantially pure in the sense that they only contain terminal unsaturation and is substantially free of any product which carries internal unsaturation.

The α-olefins to be (co)polymerised suitably have 3 to 25 carbon atoms, preferably 3-10 carbon atoms which may be copolymerised with ethylene. The reactant α-olefin may be essentially pure α-olefins or mixtures of α-olefins with ethylene or dienes such as eg 1,7-octadiene, or, with inert diluents such as saturated hydrocarbons and halogenated solvents and/or minor amounts of other olefins. Preferred α-olefins are propylene, 1-butene or 1-decene. Preferred saturated hydrocarbon diluents are C4 hydrocarbons.

It is preferred to add the Group III metal alkyl to the olefin feedstock before addition of the metallocene and aluminoxane.

The catalysts of the present invention are particularly suitable for use in continuous liquid phase or in continuous fixed bed (co)polymerisation processes.

By using a fixed bed of the supported catalyst easy separation of catalyst and product may be achieved allowing isolation of a product containing very low catalyst residues beneficial for both the further functionalisation of the product as well as ensuring effective use of the catalyst system in a continuous process.

Catalyst separation may also be facilitated in a continuous liquid phase process by judicious selection of catalyst particle size which would allow easy physical separation of catalyst from product.

Operation of a continuous fixed bed process also allows control of residence time by controlling the feed rate. This may allow fine control of product molecular weight in addition to the usual method of temperature variation. For instance, for a given zirconocene catalyst according to the present invention, increasing the reaction temperature is likely to decrease the molecular weight of the (co)polymer product whereas increasing the monomer concentration is likely to increase the molecular weight of the polymer. Whichever technique is used, the polymers made using the catalysts of the present invention have a low molecular weight distribution, ie Mw/Mn=1.5 to 3, wherein Mw represent the weight average molecular weight and Mn represents the number average molecular weight of the (co)polymer.

Thus, according to a further embodiment, the present invention is a process for the preparation of substantially pure terminally-unsaturated polymers or copolymers of α-olefins, said process comprising polymerising or co-polymerising the α-olefin(s) in the presence of a catalyst system as hereinbefore described.

The (co)polymerisation reaction is suitably carried out in the liquid or vapour phase. Where it is carried out in the liquid phase, it is preferable that the reactants and catalysts are dissolved in a diluent which may be a saturated/unsaturated or aromatic hydrocarbon or a halogenated hydrocarbon which is/are normally inert under the reaction conditions and which do not interfere with the desired (co)polymerisation reaction. Examples of suitable solvents that may be used include inter alia toluene, xylene, isobutane, propane, hexane, propylene etc. It is important that the reactants, catalysts and solvents, if any, used are pure and dry and contain no polar groups or contaminants.

The (co)polymerisation reaction is suitably carried out at a temperature in the range from 20 to 150° C., preferably in the range from 50 to 100° C. If it is desired to vary the molecular weight of a product (co)polymer for a given catalyst this variation—whilst difficult—is conventionally achieved by a significant change in the reaction conditions. For instance, more dilution may be needed or the reaction may have to be run at higher temperatures to achieve a product of relatively lower molecular weight. Raising the temperature within this range is not favoured since this may lead to α-olefin mis-insertion into the growing (co)polymer chain thereby leading to earlier termination and to the formation of less favoured internal olefin functionality in the (co)polymer. However, using the novel metallocene catalyst systems of the present invention, the molecular weight may be more easily controlled/varied by change of the nature of the leaving groups for a given catalyst system without sacrificing the benefit of high vinylidene content in the product (co)polymer.

The terminally unsaturated polymers of the present invention can be used either directly or be readily further derivatised using the high terminal unsaturation to make products suitable for use as fuel and lubricant additives such as dispersants, wax modifiers, flow improvers, dispersant-viscosity index improvers, viscosity modifiers and the like. The molecular weight of the polymers prepared according to the present invention are tailored according to the application required. For example Mn is maintained in the range from about 300 to about 10,000 for dispersant applications and from about 15,000 to about 500,000 for viscosity modifier applications. Where the polymer is required to have some dispersancy performance it is necessary to introduce polar functionality which enables the molecule to bind well to engine deposits and sludge forming materials.

Thus according to another aspect of the present invention there is provided a method of controlling the molecular weight of substantially terminally unsaturated atactic polymers or copolymers of α-olefins having a molecular weight in the range 300-500,000 by use of a catalyst system as hereinbefore described.

The reaction is suitably carried out in pressure range 1040 bar but can be carried out at lower or higher pressures. The duration of the reaction is suitably in the range from 1 to 20 hours, preferably from 1 to 10 hours, and is usually from 1 to 3 hours.

The reaction when complete is terminated by venting the reactor and reducing the reaction temperature to about 20° C. A lower alcohol such as eg isopropanol can be added to the reactor after venting in order to quench the catalyst. The resulting (co)polymer which is in solution in the reaction solvent such as eg toluene is then drained from the base of the reactor and the reactor then washed with the reaction solvent. A solution of the reaction product in the reaction solvent is then washed with a small amount of dilute acid, eg hydrochloric acid, and then with distilled water, dried with magnesium sulphate, filtered and the reaction solvent removed by evaporation on a rotary evaporator. The evaporation is suitably carried out at 120 mbar pressure (although higher vacuums can be used) at 85° C. for about 3 hours and the oligomer/polymer is then recovered as residue.

A further feature of the present process is that the (co)polymers thus formed have a relatively low level of catalyst, cocatalyst or support residues when compared with (co)polymers obtained by (co)polymerisation using conventional catalyst/cocatalyst processes whether in slurry or dissolved form.

Furthermore the catalyst and reaction conditions are controlled such that the process produces essentially non crystalline (co) polymers. Absence of crystallinity is desirable to prevent the formation of cloudy and/or aggregated solutions. For polymers of α-olefins it is necessary to ensure that the polymers are atactic. When ethylene is used as a comonomer, it is important to control the ethylene concentration and distribution in the copolymer such that there are insufficient run lengths of ethylene segments present to give rise to crystallinity. For this reason it is necessary to limit the mole fraction of ethylene present in the (co) oligomer to less than 70 mole %, preferably less than 50 mole % and to ensure that the monomer feed ratio is well controlled throughout the reaction.

According to another aspect of the present invention there are provided substantially terminally unsaturated atatic polymers or copolymers of α-olefins having molecular weight in the range 300-500,000 prepared using a catalyst system as hereinbefore described.

The present invention is further illustrated with reference to the following Examples and Comparative Tests:

The metallocene complexes used in the examples are readily available from commercial routes of preparation.

### EXAMPLES

### Polymerisation Process

### Examples 1-3, 7 and 9

The following general procedure was used to polymerise propylene. A 3-liter autoclave was thoroughly purged by heating under nitrogen. Into the autoclave was introduced (a) 1 liter of dry solvent by transfer line and (b) the required volume of triisobutylaluminium as a 1M solution in toluene. The autoclave was then sealed and 1 liter of liquid propylene transferred into it. The contents of the autoclave were then stirred at 70° C. which was maintained by external circulation through the outer jacket of the vessel. The pressure and temperature of the autoclave were logged continuously. The required amount of methylaluminoxane as a 10% by weight solution in toluene and a solution of the complex in toluene was injected into the autoclave under a positive pressure and the reaction run for the desired period. After venting, the liquid product was drained into a vessel containing a little isopropanol to destroy the catalyst. The resultant product was then washed initially with a little dilute hydrochloride acid and then with distilled water, dried with magnesium sulphate, filtered and the solvent removed by evaporation.

### Comparative Process

### Examples 4, 5, 6 and 8

The procedure of the above example was followed with the following amendment:

A 3-liter autoclave was thoroughly purged by heating under nitrogen. Into the autoclave was introduced (a) 1 liter of dry solvent by transfer line and (b) the required volume of methyl aluminoxane as a 10% solution by weight in toluene. The autoclave was then sealed and 1 liter of liquid propylene transferred into it. The contents of the autoclave were then stirred at 70° C. which was maintained by external circulation through the outer jacket of the vessel. The pressure and temperature of the autoclave were logged continuously. A solution of catalyst in toluene was injected into the autoclave under a positive pressure and the reaction run for the desired period.

### Results

| | | | | | | % | | |
|---|---|---|---|---|---|---|---|---|
| | TiBA1 | Catalyst | MAO | Run Time | Yield | Vinylidene | | Mn/ |
| Example | mmoles | umoles | umoles | mins | g | # | Mn | Mw |
| 1 | 4 | 12.5* | 1.5 | 42 | 242 | >98 | 4100 | 2.3 |
| 2 | 4 | 12.5* | 3.1 | 45 | 272 | >98 | 2800 | 2.2 |
| 3 | 4 | 12.5* | 6.2 | 42 | 245 | | 2400 | 2.4 |
| 4 | 0 | 12.5* | 6.2 | 60 | <10 | | | |
| 5 | 0 | 12.5* | 12.4 | 42 | 266 | >98 | 2400 | 2.0 |
| 6 | 0 | 12.5** | 24.8 | 60 | 176 | | 2700 | 1.9 |
| 7 | 4 | 12.5** | 1.5 | 60 | 173 | | 3200 | 2.6 |
| 8 | 0 | 25*** | 5 | 60 | <10 | | | |
| 9 | 4 | 25*** | 5 | 60 | 200 | >97 | 600 | |

*bis(1,3-dimethylcyclopentadienyl)zirconium dichloride
**bis(1 methyl-3-ethylcyclopentadienyl)zirconium dichloride
***bis(cyclopentadienyl)zirconium[triflate][hexafluoroacetylacetonate]
# As percentage of total unsaturation by 1H nmr.

The polymers were found by 13C nmr to have a pentad distribution as required for a random atactic polymer of propene.

From the examples the influence that the initial addition of the TIBA1 to the olefin feedstock has on the activity of the catalyst system can be seen. In Example 5 an increased amount of MAO is required in order to maintain the activity of Examples 1-3.

### Examples 10-11

The experiments were carried out using the general method described as above with the exception that tri(n-propyl) aluminium as a 1M solution in toluene was used in place of the tri-isobutyl aluminium. The following results were obtained:

| | | | | Run | | % | |
|---|---|---|---|---|---|---|---|
| Exam- | (N—Pr)3Al | Catalyst | MAO | Time | Yield | Vinyl- | |
| ple | mmoles | umoles | umoles | mins | g | idene | Mn |
| 10 | 6 | 12.5 | 5 | 160 | 432 | >99 | 2200 |
| 11 | 10 | 12.5 | 5 | 90 | 216 | >98 | 3200 |
| 4 | 0 | 12.5 | 6.2 | 60 | <10 | | |

The catalyst for these examples was bis (1,3-dimethylcyclopentadienyl) zirconium dichloride.

### Examples 12-13

The experiments were carried out using the general method described as above with the exception that tri(sec-butyl)boron as a 1M solution in toluene was used in place of the tri-isobutyl aluminium. The following results were obtained:

| Ex- | | | | Run | | % | |
|---|---|---|---|---|---|---|---|
| am- | (sec-Bu)3B | Catalyst* | MAO | Time | Yield | Vinyl- | |
| ple | mmoles | umoles | umoles | mins | g | idene | Mn |
| 12 | 4 | 12.5 | 5 | 40 | 150 | >98 | 800 |
| 13 | 8 | 12.5 | 5 | 70 | 310 | >98 | 1000 |
| 4 | 0 | 12.5 | 6.2 | 60 | <10 | | |

*The catalyst for these examples was bis(1,3-dimethylcyclopentadienyl)zirconium dichloride

1. A catalyst system suitable for use in the preparation of substantially terminally unsaturated atactic polymers or copolymers of α-olefins having a number average molecular weight in the range 300-500,000 said catalyst system comprising
(A) a metallocene of formula:
[RₘCpH₍₅₋ₘ₎][RₙCpH₍₅₋ₙ₎]M(Z)Y
wherein
CpH is a cyclopentadienyl ligand,
each R represents an alkyl or an aryl substituent on the CpH ligand or two R's may be joined together to form a ring, or the Rs in each Cp group when taken together represents an Si or C bridging group linking two CpH groups wherein said Si or C group may itself be substituted by hydrogen atoms or C1-C3 alkyl groups,
M is a metal selected from hafnium, zirconium and titanium,
Z and Y are selected from hydrogen, halide, a trifluoromethane sulphonate, a 1,3-diketone, a β-ketoester, an alkyl or an aryl group and may be the same or different,
each of m and n is the same or different and has a value of 0 to 5, and
(B) a cocatalyst comprising (i) an aluminoxane and (ii) a Group III metal alkyl compound having at least 2 carbon atoms.

2. A catalyst system according to claim 1 wherein the R groups are alkyl and the metal is zirconium.

3. A catalyst system according to claim 1 wherein the Z and Y groups are halogen, trifluoromethane sulphonate, 1,3-diketone or a β-ketoester.

4. A catalyst system according to claim 1 wherein the aluminoxane is methyl aluminoxane.

5. A catalyst system according to claim 1 whererin the Group III metal alkyl is a trialkyl aluminium or trialkyl boron compound.

6. A catalyst system according to claim 5 wherein the trialkylaluminium compound is triisobutylaluminium.

7. A catalyst system according to claim 1 wherein the ratio of the Group III metal alkyl compound to the aluminoxane is in the range 100:1 to 1:0.01:1.

8. A catalyst system according to claim 1 wherein the ratio of the metal to aluminoxane is in the range 1:1 to 1:2000.

9. A catalyst system according to claim 8 wherein the ratio is in the range 1:50 to 1:400.

10. A catalyst system according to claim 1 wherein the metallocene and/or the cocatalyst is supported.

11. A catalyst system according to claim 10 wherein the support is silica.

12. A process for the preparation of substantially pure terminally unsaturated polymers or copolymers of α-olefins or copolymers of α-olefins with ethylene said process comprising polymerising or co-polymerising the α-olefin in the presence of a catalyst system according to claim 1.

13. A process according to claim 12 wherein the α-olefin is propylene.

14. A process according to claim 12 wherein the α-olefin is 1-butene.

15. A process according to claim 12 wherein the α-olefin is 1-decene.

16. A process for controlling the molecular weight of substantially terminally unsaturated atactic polymers or copolymers of α-olefins having a molecular weight in the range 300-500,000 by use of a catalyst system according to claim 1.

17. Substantially terminally unsaturated atactic polymers or copolymers of α-olefins having a number average molecular weight in the range 300-500,000 prepared by use of a catalyst system according to claim 1.
